(19) United States
(12) Patent Application Publication
(10) Pub. No.: US 2016/0059362 A1
(43) Pub. Date: Mar. 3, 2016

(54) FLUX COMPOSITION AND BRAZING SHEET

(71) Applicant: KABUSHIKI KAISHA KOBE SEIKO SHO (KOBE STEEL, LTD., Hyogo (JP)

(72) Inventors: Nobuhiro KOBAYASHI, Kobe-shi (JP); Satoshi YOSHIDA, Kobe-shi (JP); Toshiki UEDA, Moka-shi (JP); Shimpei KIMURA, Moka-shi (JP); Takahiro IZUMI, Moka-shi (JP)

(73) Assignee: Kabushiki Kaisha Kobe Seiko Sho (Kobe Steel, Ltd.), Kobe-shi, Hyogo (JP)

(21) Appl. No.: 14/782,513

(22) PCT Filed: Apr. 16, 2014
(86) PCT No.: PCT/JP14/60864

§ 371 Date: Oct. 5, 2015

(30) Foreign Application Priority Data
Apr. 25, 2013 (JP) 2013-093017

(51) Int. Cl. B23K 35/36; B23K 35/28; C22C 21/06; B23K 35/02

(52) U.S. Cl. CPC B23K 35/3605; B23K 35/0238; B23K 35/286; C22C 21/06

(57) ABSTRACT

This brazing flux composition for an aluminum alloy is characterized by containing [A] a flux component containing KAlF₄ and [B] a fluoride that does not contain K and that contains elements other than group 1 elements and group 2 elements: being in a particle form of single component of [B] the fluoride; and the added amount (C) (mass %) of [B] the fluoride with respect to [A] the flux component and the average particle size (d) (μm) satisfying formula (1),

0.83C−0.19d<43 (1).

### TECHNICAL FIELD

The present invention relates to a flux composition for brazing an aluminum alloy material, and to a brazing sheet using the flux composition.

### BACKGROUND ART

With increasing concerns about environmental issues in recent years, weight reduction has been under progress intending to improve fuel efficiency, for example, in automobile industries. To meet the requirement for weight reduction, investigations have been made vigorously so as to allow aluminum clad materials (brazing sheets) for automobile heat exchangers to have reduced wall thickness and higher strength. The brazing sheets generally have a three-layered structure including a sacrificial material (for example, Al—Zn material), a core material (for example, Al—Si—Mn—Cu material), and a brazing filler metal (for example, Al—Si material) in this order. For achieving higher strength, investigations have been made to add magnesium (Mg) to the core material, that is, to strengthen by Mg₂Si precipitation.

Further, a flux brazing method is generally used for the joining of a brazing sheet upon assembling a heat exchanger. The flux improves brazeability, and those containing KAlF₄ as a main component are generally used.

However, a brazing sheet having a core material comprising a magnesium-containing aluminum alloy has a disadvantage of hindering the brazeability when a customary flux is used. This is considered to be attributable to that magnesium in the core material migrates into the flux at the surface of the brazing filler metal during heating for brazing, and the magnesium reacts with the flux component to form high melting point compounds (such as KMgF₃ and MgF₂), thereby consuming the flux component. Accordingly, development of a flux composition for a magnesium-containing aluminum alloy is required so as to advance the weight reduction, for example, of automobile heat exchangers.

Under these circumstances, as a brazing sheet having a magnesium-containing aluminum alloy as a core material for improving the brazeability of the brazing sheet, there have been made investigations on (1) a flux composition of adding CsF to a customary flux component (refer to Japanese Unexamined Patent Application Publication No. Sho 61(1986)-162295); and (2) a flux composition with addition of CaF₂, NaF, or LiF to a customary flux component (refer to Japanese Unexamined Patent Application Publication No. Sho 61(1986)-99569).

However, the flux composition (1) with addition of CsF is not suitable for mass production and is less practical, since Cs is very expensive. On the other hand, in the flux composition (2) with addition of CaF₂, etc., since the addition of the compounds lowers the melting point, fluidity of the flux is improved. However, since the flux and magnesium react also in this flux composition as in the customary case, the brazeability is not improved sufficiently. Generally, it is known that the brazeability is improved by increasing the coating amount of the flux. However, since increase of the coating amount increases the cost, development of a flux enabling excellent brazing at low cost has been demanded.

### CITATION LIST

### Patent Literature

PTL 1: Japanese Unexamined Patent Application Publication No. Sho 61-162295

PTL 2: Japanese Unexamined Patent Application Publication No. Sho 61-99569

### SUMMARY OF INVENTION

### Technical Problem

The present invention has been made under these circumstances, and an object thereof is to provide a flux composition, which is excellent in fluidity and can improve brazeability even in a small coating amount when used in the brazing of a magnesium-containing aluminum alloy material, and a brazing sheet using the flux composition.

### Solution to Problem

The present inventors have focused attention on a cause deterioration of brazeability for a magnesium-containing aluminum alloy that not only magnesium and the flux component (KAlF₄) react each other to form magnesium-containing high melting point compounds as has been reported so far, but also high melting point K₃AlF₆ is formed in the course of the reaction. The present inventors have focused also on that when an additive having a melting point higher than that of the flux is contained in the flux composition, the flux is melted preferentially and flows in a state where a solid additive is present in a liquefied flux component. When the solid phase rate as a volume rate of solid in the liquid is higher, the apparent viscosity of the molten flux increases to deteriorate the fluidity of the flux. Then, the present inventors have found that the brazeability can be improved by coexisting a specified fluoride enabling effective utilization of K₃AlF₆ together in the flux component and that the fluidity of the flux can be improved by controlling the solid phase rate by adjustment of the particle diameter and the addition amount of the fluoride, to accomplish the present invention.

That is, the invention accomplished for solving the subject provides a flux composition for brazing an aluminum alloy material containing:

[A] a flux component containing KAlF₄ (hereinafter also simply referred to sometimes as a “flux component [A]”), and

[B] a fluoride comprising elements other than Group 1 elements and Group 2 elements and not containing K (potassium) (hereinafter also simply referred to sometimes as a “fluoride [B]”), and in which

the fluoride [B] is in a particle form of single component, and
an addition amount C (mass %) of the fluoride [B] to the flux component [A] and an average particle diameter d (μm) satisfy the following formula (1):

0.83C−0.19d<43 (1)

It is considered that since the flux composition contains the fluoride [B], when the flux composition is used for brazing a magnesium-containing aluminum alloy material, the fluoride [B] can react with K₃AlF₆, which is formed during brazing to form KAlF₄. Accordingly, the flux composition can suppress decrease of KAlF₄ which is necessary for improving the brazeability and can improve the brazeability even by a small coating amount. Further, the flux composition is applicable also to the brazing of an aluminum alloy material not containing magnesium and is usable in wide applications.

Further, in the flux composition, the addition amount C (mass %) and the average particle diameter d (μm) of the fluoride [B] satisfy the formula (1). Summarizing the gist of the formula is summarized as below. The volume of particles immersed in the molten flux is suppressed and the solid phase rate is restricted within a predetermined range by decreasing the addition amount C when the average particle diameter d of the fluoride [B] is smaller and, on the contrary, by increasing the addition amount C when the average particle diameter d is larger. As a result, an apparent viscosity of the molten flux is lowered to provide high fluidity.

Further, in the flux composition, since the fluoride [B] is in a particle form of single component and the flux component [A] and the fluoride [B] are separate components, increase of the melting point of the flux component [A] by the presence of the fluoride [B] can be suppressed and, as a result, deterioration of the fluidity of the flux can be prevented, to effectively provide the effect of improving the brazeability.

The average particle diameter d of the fluoride [B] is preferably 0.1 μm or more and 300 μm or less. By defining the average particle diameter [B] of the fluoride [B] within the range as described above, the effect of improving the brazeability and the effect of improving the fluidity of the flux composition can be developed effectively.

The fluoride [B] is preferably AlF₃. It is considered that KAlF₄ can be formed from K₃AlF₆ more efficiently by the use of AlF₃ as the fluoride [B].

The flux component [A] is preferably in a particle form of single component. When the flux component [A] is also in the particle form of single component, the flux composition can be handled easily and increase in the melting point of the flux component [A] caused by the presence of the fluoride [B] can be suppressed easily and reliably.

A brazing sheet according to the present invention includes a core material comprising an aluminum alloy, a brazing filler metal laminated on at least one side of the core material, and a flux layer laminated on one side of the brazing filler metal and comprising the flux composition. Since the brazing sheet uses the flux composition, the brazeability is excellent.

A coating amount of the flux composition in the flux layer is preferably 0.5 g/m² or more and 100 g/m² or less in terms of solid content. According to the brazing sheet, since the amount of the flux composition used is controlled within the small range described above, the production cost can be saved while providing excellent brazeability.

The aluminum alloy preferably contains magnesium. Since the core material uses the magnesium-containing aluminum alloy, the weight of the brazing sheet can be reduced. On the other hand, since the flux layer is formed of the flux composition in the brazing sheet, excellent brazeability can be provided even when the magnesium-containing aluminum alloy is used.

“Average particle diameter d” means such a particle diameter that the ratio of passing mass is 50% from the side of a small diameter in the distribution of the particle diameter measured by a laser diffraction scattering method, and “particle diameter” means the length of the longest chord of the particle. Further, “coating amount of the flux composition” is a value calculated by dividing the solid mass (g) of the flux composition with an area (m²) of one side of the core material.

### Advantageous Effects of Invention

As has been described above, the flux composition according to the present invention can be used widely for brazing an aluminum alloy material regardless of whether it contains magnesium or not. In particular, since the flux composition is excellent in the fluidity, it can improve the brazeability even by a small coating amount when used for brazing a magnesium-containing aluminum alloy material. Further, since the brazing sheet of the present invention uses the flux composition described above, it has excellent brazeability. Then, a structure brazed by the brazing sheet of the present invention can provide both a high strength and a reduced weight together and is usable, for example, in automobile heat exchangers.

### DESCRIPTION OF EMBODIMENTS

Then, the flux composition of the present invention and the embodiment of the brazing sheet will be described in details successively.

### [Flux Composition]

The flux composition according to the present invention is used for brazing an aluminum alloy material. The flux composition includes a flux component [A] containing KAlF₄ and a fluoride [B] in a particle form of single component containing an element other than Group 1 elements and Group 2 elements and not containing potassium (K).

Since the flux composition contains the fluoride [B], it is considered that when the flux composition is used in the brazing of a magnesium-containing aluminum alloy material, the fluoride [B] can react with K₃AlF₆ to form KAlF₄. Accordingly, the flux composition can suppress decrease of KAlF₄ which is necessary for improving the brazeability even when it is used in a small coating amount (deposition amount). In addition, the fluoride [B] does not hinder brazing by the flux component [A]. Accordingly, the flux composition is applicable also to the brazing of an aluminum alloy material not containing magnesium and usable in wide applications. Respective components will be described below.

### Flux Component [A]

The flux component [A] is not particularly restricted so long as this is a brazing flux component containing KAlF₄. The flux component [A] exhibits a function of melting preferentially to the component of a brazing filler metal in the course of heating and temperature elevation process during brazing to remove oxide films on the surface of the aluminum alloy material, and covering the surface of the aluminum alloy material to prevent aluminum from re-oxidation.

The flux component [A] may further contain other components than KAlF₄. The other components than KAlF₄ are not particularly restricted and include those contained in known flux components. Such optional components include, for example, other fluorides such as KF, K₂AlF₅, and K₃AlF₆, and hydrates such as K₂(AlF₅)(H₂O). It is considered that in the other components, for example, K₂AlF₅ reacts with Mg in the course of heating for brazing to form K₃AlF₆, the resulting K₃AlF₆ reacts with the fluoride [B] to form KAlF₄ and, as a result, contributes to the improvement of the brazeability as described above. It is considered that a similar effect is also provided when K₃AlF₆ is initially present in the flux component [A] since K₃AlF₆ reacts with the fluoride [B]. Even when other components than the essential component KAlF₄ are contained. It is considered that the effects of the present invention can be provided by allowing the fluoride [B] to exist in such a state where K₃AlF₆ is formed or is present as described above.

While the content of KAlF₄ in the flux component [A] is not particularly restricted, it is preferably 50 mass % or more, and, more preferably, 70 mass % or more.

The existent form of the flux component [A] is not particularly restricted and a single component particle state is preferred. The shape of the particle is not particularly restricted and, for example, spherical or amorphous shape is adopted. When both of the flux component [A] and the fluoride [B] are in the particle form of single component, increase in the melting point of the flux component [A] due to the presence of the fluoride [B] can be suppressed to further improve the brazeability as a result. Further, since the flux composition forms aggregates of particles, handling can be facilitated.

Increase of the melting point of the flux composition to the melting point of the flux component [A] is preferably 15° C. or lower and, more preferably, 10° C. or lower. The upper limit of the melting point of the flux composition is preferably 580° C. and, more preferably, 570° C. Higher brazeability can be provided by restricting increase in the melting point of the flux composition. The lower limit of the melting point of the flux composition is not particularly restricted but, for example, it can be 520° C. and, preferably, 540° C.

### Fluoride [B]

The fluoride [B] is not particularly restricted so long as the fluoride contains an element other than Group 1 elements (hydrogen, lithium, sodium, potassium, rubidium, cesium, and francium) and Group 2 elements (beryllium, magnesium, calcium, strontium, barium, and radium) but does not contain K (potassium). However, the fluoride [B] is preferably such a component that can react with K₃AlF₆ which is a high melting point compound formed in the course of the brazing of a magnesium-containing aluminum alloy material to form KAlF₄, although the mechanism thereof has not yet been apparent.

The fluoride [B] includes, for example, AlF₃, CeF₃, etc. Among them, preferred are fluorides containing Group 13 elements (for example, boron, aluminum, gallium, indium, etc.), aluminum-containing fluorides are more preferred, and fluorides of Group 13 elements are also more preferred. Among them, AlF₃ is particularly preferred. When AlF₃ is used, KAlF₄ can be formed from K₃AlF₆ more efficiently. AlF₃ may be a hydrate, but is preferably an anhydride.

The form of the flux [B] present in the flux composition is a particle form not containing the flux component [A]. When the fluoride [B] is in the particle form, the rate of impregnation of the fluoride [B] in the molten flux can be lowered to decrease the solid phase rate. The shape of the particle of the fluoride [B] is not particularly restricted and a spherical shape or an amorphous shape can be adopted. Further, as described above, when the flux component [A] and the fluoride [B] are formed as separate particles respectively, increase in the melting point of the flux component [A] can be suppressed to further improve the brazeability.

The addition amount C (mass %) of the fluoride [B] to the flux component [A] and the average particle size d (μm) satisfy the following formula (1):

0.83C−0.19d<43 (1).

The formula (1) is derived by the procedures as described below. First, for measuring the fluidity of the flux, a fluoride-containing flux composition containing a flux component [A] and a fluoride [B] suspended in 100 ml of ion exchanged water was dropped to the center on a test plate made of Al or Al—Mg alloy (0.2 mm thickness, 50 mm square) so as to form about φ10 mm and dried to remove the water content. Particle form flux component [A] containing 80 vol % of KAlF₄ and 20 vol % of K₂(AlF₅)(H₂O) was used. Particle form AlF₃ was used as the fluoride [B]. The suspended flux composition was coated in this way and the ion exchanged water is removed by drying so that each of the powdered components could be coated uniformly. The fluoride-containing flux composition was heated to 600° C. for 10 minutes in an atmosphere at a dew point of −40° C. and an oxygen concentration of 100 ppm. A heating rate is 50° C./min in average. An area before heating and an area after heating of the flux on the test plate were measured by image analysis and converted radii when they are converted respectively into true circle areas were calculated. A flow volume rate s1 (m³/g) of the fluoride-containing flux composition as a specific volume obtained by dividing the difference (mm) between the converted radius of the area after heating and the conversion radius of the area before heating by a dropping amount (coating amount) (g/m²) of the flux was determined. The test was repeated while properly changing the magnesium content of the test plate and the dropping amount of the flux, to determine the flow volume rate s1 of the fluoride-containing flux composition under each of conditions. The coating amount of the flux was calculated by dividing the solid mass (g) of the flux with the area on one side of the test plate (0.0025 m²).

Then, a non fluoride containing flux composition containing the flux component [A] but not containing the fluoride [B] was used, and a fluidity measuring test was performed in the same manner as that for the fluoride-containing flux composition containing the flux component [A] and the fluoride [B], to determine a flow volume rate s2 (m³/g) of the not fluoride-containing flux composition as a specific volume obtained by dividing the difference (mm) between the converted radius of area after heating and the converted radius of area before heating. In the same manner as that for the fluoride-containing flux composition, the test was repeated while properly changing the magnesium content in the test plate and the dropping amount of the flux, to determine the flow volume rate s2 of the not fluoride-containing flux composition under each of conditions.

Further, for the fluoride-containing flux composition and the not fluoride-containing flux composition for which the magnesium content of the test plate and the dropping amount (coating amount) of the flux were identical, a specific flow volume rate R (s1/s2×100%) as a ratio of the flow volume rate s1 of the fluoride-containing flux composition to the flow volume rate s2 of the not fluoride-containing flux composition was determined on every magnesium content of the test plate and the dripping amount of the flux. The specific flow volume rate R means that as the value R is larger the fluidity is also deteriorated by the addition of the fluoride [B] and thus the fluidity is more excellent.

A multiple regression was performed with the specific flow volume rate R determined in the test described above as a target variable and the addition amount C (mass %) of the fluoride [B] to the flux component [A] and the average particle diameter d as descriptive variables, to obtain the relation of the following formula (2).

R=103−0.83C+0.19d (2)

In the flux composition, the specific flow volume rate R is preferably 60% or more. That is, a sufficient fluidity for brazing can be ensured when R>60. When the relation is applied to the formula (2), the following formula (3) is obtained and the formula (3) is arranged to derive the formula (1).

R=103−0.83C+0.19d>60 (3)

The upper limit of the addition amount C of the fluoride [B] to the flux component [A] is not particularly restricted and this is preferably 200 mass %, more preferably, 100 mass % and, further preferably, 60 mass %. If the addition amount C of the fluoride [B] exceeds the upper limit, the content of the flux component [A] in the flux composition is relatively lowered to possibly deteriorate the brazeability.

Also the lower limit of the addition amount C of the fluoride [B] to the flux component [A] is not particularly restricted and is preferably 1 mass %, more preferably, 2 mass % and, further preferably, 10 mass %. If the addition amount of the fluoride [B] is less than the lower limit, the effect of the present invention cannot possibly be provided sufficiently.

The upper limit of the average particle diameter d of the fluoride [B] is preferably 300 μm, more preferably, 200 μm and, further preferably, 150 μm. If the average particle diameter d of the fluoride [B] exceeds the upper limit, the fixing property of the flux composition to the brazed material may be possibly deteriorated and the particle diameter is larger than the nozzle diameter in a case of using spray coating, thereby making the spray coating impossible.

The lower limit of the average particle diameter d of the fluoride [B] is preferably 0.1 μm, more preferably, 1 μm and, further preferably, 5 μm. If the average particle diameter of the fluoride [B] is less than the lower limit, the solid phase rate in the flux composition increases to possibly deteriorate the fluidity, and the manufacture of particles may be possibly difficult.

The flux composition may also contain other components than the flux component [A] and the fluoride [B] within a range not hindering the effect of the present invention. Such components include, for example, a melting point lowering agent. When the melting point lowering agent is contained, increase in the melting point of the flux component [A] can be suppressed to further improve the brazeability.

The melting point lowering agent is a component having an effect of suppressing the increase in the melting point of the flux component [A]. The melting point lowering agent is not particularly restricted so long as it has the effect described above and includes fluorides of alkali metals and alkaline earth metals other than potassium, for example, NaF, LiF, CsF, and CaF₂. Among them, alkali metal fluorides are preferred, and NaF and LiF are more preferred. When NaF and LiF are used, the brazeability can be improved by lowering of the melting point. The melting point lowering agents may be used each alone or in admixture of one or more of them.

The addition amount of the melting point lowering agent is not particularly restricted, and is preferably 0.1 parts by mass or more and 30 parts by mass or less and, more preferably, 0.5 parts by mass or more and 20 parts by mass or less per 100 parts by mass of the flux component [A]. If the addition amount of the melting point lowering agent exceeds the upper limit, the content of the flux component [A] is lowered relatively, to possibly deteriorate the brazeability. On the other hand, if the addition amount of the melting point lowering agent is less than the lower limit, the effect of containing the melting point lowering agent may not possibly be obtained.

The state of the flux composition is not particularly restricted and is usually powdered. However, the flux composition may also be in other forms such as a solid or pasty form.

A method of manufacturing the flux composition is not particularly restricted and the flux component [A], the fluoride [B] and, optionally, the melting point lowering agent, etc. are mixed at an appreciate ratio. The mixing method includes (1) a method of uniformly mixing respective powdered components each other to obtain a powdered flux composition, (2) a method of mixing respective powdered components each other, heating the mixture in a crucible or the like within such a range that the fluoride [B] is not melted, and then cooling the mixture to obtain a solid or powdered flux composition, and (3) a method of suspending respective powdered components in a solvent such as water to obtain a pasty or slurry form flux composition. The method of (1) or (3) is preferred in order to incorporate particles comprising the flux component [A] and particles comprising the fluoride [B] as described above.

### (Method of Using Flux Composition)

A method of using the flux composition of the present invention (brazing method using the flux composition of the present invention) will be described below. Since the flux composition of the present invention has high fluidity and exhibits excellent brazeability even in a small coating amount (deposition amount), economically excellent brazing can be performed by using the flux composition of the present invention.

An aluminum alloy material to be brazed with the flux composition is not particularly restricted and may or may not contain magnesium. In order to achieve the weight reduction of material and to allow the flux composition to exhibit the effect more sufficiently, a magnesium-containing aluminum alloy material is preferred. The aluminum alloy material may be a material only consisting of aluminum alloy or a multilayered composite material having a layer only consisting of an aluminum alloy and a layer comprising another material (for example, a brazing sheet). A target to which the flux composition is attached is not restricted to a brazing filler metal so long as the target is an aluminum alloy material, but may also be a sacrificial material or the like.

When the aluminum alloy material (aluminum alloy) contains magnesium, the upper limit of the magnesium content is preferably 1.5% by mass, more preferably, 1.0% by mass and, particularly preferably, 0.5% by mass. If the magnesium content exceeds the upper limit, the flux composition cannot possibly exhibit brazeability sufficiently. The lower limit of the magnesium content in the aluminum alloy material (aluminum alloy) is not particularly restricted and, for example, 0.01 mass %.

A brazing filler metal used in the brazing method is not particularly restricted and known materials can be used. Preferred brazing filler metals are those having melting point higher than that of the flux component [A] by about 10° C. to 100° C. and include, for example, Al—Si alloys. Al—Si alloys having an Si content of 5 parts by mass or more and 15 parts by mass or less are more preferred. Such Al—Si alloys (brazing filler metals) may further contain other components such as Zn and Cu.

A deposition method of the flux composition to a brazed portion is not particularly restricted and includes, for example, a method of coating a powdered flux as it is by using spray, etc., and a method of coating and immersing a slurry or pasty flux composition to the brazing portion, and evaporating a dispersion component while depositing only the flux composition. The dispersion component is usually water and, in addition, organic solvents such as alcohols can also be used.

The lower limit of the deposition amount of the flux composition to the brazing portion is preferably 0.5 g/m² and, more preferably, 1 g/m² in terms of a solid content. When the deposition amount of the flux composition is at or higher than the lower limit, sufficient brazeability can be provided. On the other hand, the upper limit of the deposition amount of the flux composition is, preferably, 100 g/m², more preferably, 60 g/m², furthermore preferably, 20 g/m² and, particularly preferably, 10 g/m² in terms of the solids content. When the deposition amount of the flux composition is defined to the upper limit or less, the amount of the flux composition to be used can be decreased to achieve cost reduction while maintaining the brazeability.

After depositing the flux composition as a suspension (slurry or paste) to the brazing portion, the brazing portion is usually dried. Then, brazing can be performed by heating and melting the flux component and the brazing filler metal at a temperature lower than the melting point of the aluminum alloy as the core material and higher than the melting point of the flux (for example, from 580° C. to 615° C.).

A temperature elevation rate upon heating may be, for example, from about 10° C. to 100° C./min. The heating time is not particularly restricted and is preferably shorter so as to reduce the migration amount of magnesium that hinders the brazeability. The heating time is, for example, about 5 to 20 minutes.

The heating may be performed under known ambient conditions and preferably in a non-oxidizing atmosphere such as an inert gas atmosphere. An oxygen concentration during heating is preferably 1,000 ppm or less, more preferably, 400 ppm or less and, furthermore preferably, 100 ppm or less from the viewpoint of suppressing oxidation. A dew point of the atmosphere during heating is preferably −35° C. or lower.

The flux composition is also usable for brazing an aluminum alloy material not containing magnesium. The flux composition is applicable also to a flux layer of a brazing sheet including an aluminum alloy not containing magnesium as the core material.

### (Brazing Sheet)

The brazing sheet of the present invention includes a core material comprising an aluminum alloy, a brazing filler metal laminated on at least one surface of the core material, and a flux layer laminated on one side (surface) of the brazing filler metal and comprising the flux composition. A layer structure of the core material and the brazing filler metal in the brazing sheet includes a structure having three or more layers, such as brazing filler metal/core material/brazing filler metal (three-layered structure with brazing filler metal on both sides), brazing filler metal/core material/intermediate layer/brazing filler metal (four-layered structure).

Since the brazing sheet has the flux layer comprising the flux composition on the surface of the brazing filler metal, even in a case of using a core material comprising a magnesium-containing aluminum alloy, decrease of KAlF₄ associated with the formation of high melting point compounds derived from magnesium in the core material can be suppressed during brazing. Further, the flux composition has high fluidity and spreads over the brazing surface uniformly. Accordingly, the brazing sheet can therefore improve the brazeability.

While the core material is not particularly restricted so long as it is an aluminum alloy, it is preferably a magnesium-containing aluminum alloy. When the magnesium-containing aluminum alloy is used for the core material, weight of the brazing sheet can be reduced. On the other hand, in the brazing sheet, since the flux layer is formed of the flux composition, excellent brazeability can be provided even when the magnesium-containing aluminum alloy is used. When the magnesium-containing aluminum alloy is used as the core material, the magnesium content in the core material is preferably within the range as explained above for the aluminum alloy material.

The brazing filler metal includes those described for the method of using the flux composition.

The flux layer is a layer comprising the flux composition. A method of forming the flux layer is not particularly restricted and includes, for example, a method of coating a pasty or slurry flux composition to the surface of the brazing filler metal, etc.

The lower limit of the coating amount of the flux composition in the flux layer is not particularly restricted, and is preferably 0.5 g/m² and, more preferably, 1 g/m². When the coating amount of the flux composition is at the lower limit or more, sufficient brazeability can be provided. On the other hand, the upper limit of the coating amount of the flux composition is at preferably 100 g/m², more preferably, 60 g/m², furthermore preferably, 20 g/m² and, particularly preferably, 10 g/m². When the coating amount of the flux composition is at the upper limit or less, the amount of the flux composition to be used can be suppressed to achieve cost reduction while maintaining the brazeability.

The size of the brazing sheet is not particularly restricted and any known size can be used. For example, the thickness of the brazing sheet is, for example, from 0.1 mm to 2 mm. A method of manufacturing the brazing sheet is not particularly restricted and can be manufactured by a known method.

The brazing sheet may further comprise a sacrificial material that is laminated on the other side of the core material and has a potential more basic than that of the core material. When the brazing sheet has the sacrificial material, corrosion resistance can be improved further.

A material of the sacrificial material is not restricted so long as the potential is more basic than that of the core material. The material includes, for example, Al—Zn alloys having a Zn content of 1 to 10 mass %, and Al alloys comprising 0.5 to 1.1 mass % of Si and 2.0 mass % or less of Mg added to the Al—Zn alloy.

### (Method of Using Brazing Sheet of Present Invention)

The brazing sheet can be used (brazed) by a known method. Heating conditions (for example, temperature, temperature elevation rate, oxygen concentration, etc.) during brazing includes conditions described for the brazing method mentioned above.

### (Structure)

A structure formed by brazing an aluminum alloy material using the flux composition or formed from the brazing sheet is firmly joined at a brazing portion. Accordingly, in the structure described above, high strength and weight reduction are compatible as a structure using an aluminum alloy, preferably, a magnesium-containing aluminum alloy.

Specifically, the structure includes automobile heat exchangers such as radiators, evaporators, and condensers. In the heat exchangers higher strength and reduction of thickness are intended by using the brazing sheet preferably having a magnesium-containing aluminum alloy material (core material). Further, since the flux composition of the invention is used for such heat exchangers, they are excellent in the brazeability and brazed firmly.

### EXAMPLES

The present invention will be described more specifically with reference to examples, but the present invention is not restricted to these examples.

### Reference Examples 1 to 8

Flux compositions containing only the flux components [A] suspended each in 100 ml of ion exchanged water were applied dropwise at the center on test plates made of Al or Al—Mg alloys at magnesium contents shown in Table 1 (0.2 mm thickness, 50 mm square) by deposition amounts in Table 1 so as to form about φ10 mm and then dried to remove water content. The flux components [A] in a particle form each containing 80 vol % of KAlF₄ and 20 vol % of K₂(AlF₅)(H₂O) were used. Further, the suspended flux compositions were coated and ion exchanged water was removed by drying such that each of the powdered components could be coated uniformly. The flux compositions were heated to 600° C. for 10 minutes in an atmosphere at a view point of −40° C. and an oxygen concentration of 100 ppm or less. A heating rate is 50° C./min in average. An area before heating and an area after heating the flux on the test plate were measured by image analysis and converted radii when converted respectively into the true circle areas were calculated. A flow volume rate s (m³/g) of the flux as a specific flow volume rate obtained by dividing the difference (mm) between the converted radius of the area after the heating and the converted radius of the area before the heating by a dropping amount (coating amount) (g/m²) of the flux was determined for Reference Example 1 to 8. The coating amount of the flux was calculated by dividing the solid mass (g) of the flux with the area on one side of the test plate (0.0025 m²).

### Examples 1 to 16 and Comparative Examples 1 to 3

Flux compositions formed by adding fluorides [B] having average particle diameters shown in Table 1 by addition amounts shown in Table 1 to the flux components [A] (ratio to the flux component [A]) were used, test plates made of Al or Al—Mg alloys at magnesium contents shown in Table 1 were used, and the flux compositions were coated by the coating amounts shown in Table 1 on the test plates by the same procedures as in Reference Examples 1 to 8. Subsequently, they were heated under the conditions identical with those of Reference Examples 1 to 8 and the flowing volume rates s (m³/g) of the fluxes were determined for Examples 1 to 16 and Comparative Examples 1 to 3. AlF₃ in a particle form was used as the fluoride [B].

Further, for Examples 1 to 16 and Comparative Examples 1 to 3, values on the left side of the formula (1) (0.83C−0.19d) were calculated. Further, for each of Examples 1 to 16 and Comparative Examples 1 to 3, those in Reference Examples 1 to 8 for which magnesium contents of the test plates and flux dropping amounts (coating amounts) were identical were used as comparative reference examples, and the ratio of flow volume rates (specific flow volume rates) R of the flow volume rate of Examples 1 to 16 and Comparative Examples 1 to 3 relative to the flow volume rates s of the comparative reference examples was determined. For example, since Reference Example 1 in which the magnesium content of the test plate is 0 mass % and the flux coating amount is 3 g/m² corresponds to the comparative reference example to Example 1, the specific flow volume rate R is 0.0046/0.056×100% (=82.4%). Since Reference Example 2 in which the magnesium content of the test plate is 0.4 mass % and the flux coating amount is 1 g/m² of the test plate corresponds as the comparative reference example to Example 3, the specific flow volume rate R is 0.0047/0.063×100% (=74.4%). Values calculated for Examples 1 to 16 and Comparative Examples 1 to 3 are shown in Table 1.

The average particle diameter of the fluorides [B] was measured for a measuring range of 0.1 to 3,000 μm using a microtrack (Model No. SALD-3000S, manufactured by Shimazu Corp.)

TABLE 1

| | | [B] Fluoride | | Flux | | | | | | |
|---|---|---|---|---|---|---|---|---|---|---|
| | | Average | | | Radius | Radius | | Flow | | Flow |
| | Test plate | particle | Addition | Coating | before | after | Enlarged | volume | Left side of | volume |
| | Mg content | diameter | amount | amount | heating | heating | diameter | rate | formula (1) | rate |
| | Mass % | μm | Mass % | g/m² | mm | mm | mm | m³/g | — | % |
| Reference Example 1 | 0 | — | 0 | 3 | 6.36 | 23.07 | 16.71 | 0.0056 | — | — |
| Reference Example 2 | 0.4 | — | 0 | 1 | 5.84 | 12.14 | 6.30 | 0.0063 | — | — |
| Reference Example 3 | 0.4 | — | 0 | 3 | 5.76 | 13.76 | 8.00 | 0.0027 | — | — |
| Reference Example 4 | 0.4 | — | 0 | 10 | 6.02 | 17.22 | 11.20 | 0.0011 | — | — |
| Reference Example 5 | 0.4 | — | 0 | 40 | 6.11 | 21.22 | 15.11 | 0.0004 | — | — |
| Reference Example 6 | 0.4 | — | 0 | 70 | 5.94 | 22.76 | 16.82 | 0.0002 | — | — |
| Reference Example 7 | 0.4 | — | 0 | 100 | 6.26 | 22.88 | 16.62 | 0.0002 | — | — |
| Reference Example 8 | 0.8 | — | 0 | 3 | 5.77 | 12.22 | 6.45 | 0.0022 | — | — |
| Example 1 | 0 | 15 | 32.5 | 3 | 6.01 | 19.78 | 13.77 | 0.0046 | 24.1 | 82.4 |
| Example 2 | 0 | 140 | 32.5 | 3 | 6.03 | 21.80 | 15.77 | 0.0053 | 0.4 | 94.4 |
| Example 3 | 0.4 | 3 | 32.5 | 1 | 5.96 | 10.65 | 4.69 | 0.0047 | 26.4 | 74.4 |
| Example 4 | 0.4 | 15 | 32.5 | 1 | 6.06 | 12.34 | 6.28 | 0.0063 | 24.1 | 99.7 |
| Example 5 | 0.4 | 140 | 33.5 | 1 | 6.11 | 12.85 | 6.74 | 0.0067 | 1.2 | 107.0 |
| Example 6 | 0.4 | 3 | 10 | 3 | 5.97 | 11.69 | 5.72 | 0.0019 | 7.7 | 71.5 |
| Example 7 | 0.4 | 15 | 32.5 | 3 | 6.12 | 12.38 | 6.26 | 0.0021 | 24.1 | 78.3 |
| Example 8 | 0.4 | 35 | 32.5 | 3 | 6.11 | 13.80 | 7.69 | 0.0026 | 20.3 | 96.1 |
| Example 9 | 0.4 | 80 | 32.5 | 3 | 6.06 | 13.66 | 7.60 | 0.0025 | 11.8 | 95.0 |
| Example 10 | 0.4 | 100 | 32.5 | 3 | 5.99 | 13.84 | 7.85 | 0.0026 | 8.0 | 98.1 |
| Example 11 | 0.4 | 140 | 32.5 | 3 | 5.94 | 13.65 | 7.71 | 0.0026 | 0.4 | 96.4 |
| Example 12 | 0.4 | 15 | 32.5 | 10 | 5.78 | 13.16 | 7.38 | 0.0007 | 24.1 | 65.9 |
| Example 13 | 0.4 | 15 | 32.5 | 40 | 6.21 | 20.66 | 14.45 | 0.0004 | 24.1 | 95.6 |
| Example 14 | 0.4 | 15 | 32.5 | 70 | 6.14 | 22.22 | 16.08 | 0.0002 | 24.1 | 95.6 |
| Example 15 | 0.4 | 15 | 32.5 | 100 | 6.01 | 22.34 | 16.33 | 0.0002 | 24.1 | 98.3 |
| Example 16 | 0.8 | 140 | 32.5 | 3 | 6.23 | 12.45 | 6.22 | 0.0021 | 0.4 | 96.4 |
| Comparative Example 1 | 0.4 | 3 | 80 | 3 | 6.03 | 11.08 | 5.05 | 0.0017 | 65.8 | 63.1 |
| Comparative Example 2 | 0.4 | 3 | 56 | 1 | 5.84 | 9.37 | 3.53 | 0.0035 | 45.9 | 56.0 |
| Comparative Example 3 | 0.4 | 3 | 56 | 3 | 6.11 | 8.87 | 2.76 | 0.0009 | 45.9 | 34.5 |

As shown in Table 1, it can be seen that the flux composition of the present invention satisfying the relation (1) (Examples 1 to 16) has high specific flow volume rate R and deterioration in the fluidity is decreased even when the fluoride [B] is added. That is, according to the present invention, fluoride [B] can be added while maintaining the fluidity and, as a result, brazeability can be improved.

While the present invention has been described specifically with reference to specific embodiments, it will be apparent to a person skilled in the art that various changes or modifications can be made without departing the spirit and the scope of the invention.

The present application is based on Japanese Patent Application filed on Apr. 25, 2013 (Patent Application No. 2013-093017), the contents of which are incorporated herein for the reference.

### INDUSTRIAL APPLICABILITY

The flux composition of the present invention can be used suitably for brazing aluminum alloys, particularly, magnesium-containing aluminum alloys and, specifically, can be used, for example, to the manufacture of automobile heat exchangers made of aluminum alloys.

1: A flux composition for brazing of an aluminum alloy material, comprising:
[A] a flux component comprising KAlF₄, and
[B] a fluoride added to the flux component [A], the fluoride [B] comprising elements other than group 1 elements and group 2 elements and not comprising K;
wherein:
the fluoride [B] is in a single-component particle form, and
the addition amount C (mass %) of the fluoride [B] to the flux component [A] and the average particle diameter d (μm) of the fluoride [B] satisfy the following formula (1):
0.83C−0.19d<43 (1)

2: The flux composition according to claim 1, wherein the average particle diameter d of the fluoride [B] is 0.1 μm or more and 300 μm or less.

3: The flux composition according to claim 1, wherein the fluoride [B] is AlF₃.

4: The flux composition according to claim 1, wherein the flux component [A] is in a single-component particle form.

5: A brazing sheet, comprising:
a core material comprising an aluminum alloy,
a brazing filler metal laminated on at least one surface of the core material and
a flux layer laminated on at least one surface of the brazing filler metal, the flux layer comprising the flux composition according to claim 1.

6: The brazing sheet according to claim 5, wherein the flux layer comprises 0.5 g/m² or more and 100 g/m² or less of the flux composition in terms of solid content.

7: The brazing sheet according to claim 5, wherein the aluminum alloy comprises magnesium.

8: The flux composition according to claim 2, wherein the fluoride [B] is AlF₃.

9: The flux composition according to claim 2, wherein the flux component [A] is in a single-component particle form.

10: A brazing sheet, comprising:
a core material comprising an aluminum alloy,
a brazing filler metal laminated on at least one surface of the core material and
a flux layer laminated on at least one surface of the brazing filler metal, the flux layer comprising the flux composition according to claim 2.

11: The brazing sheet according to claim 10, wherein the flux layer comprises 0.5 g/m² or more and 100 g/m² or less of the flux composition in terms of solid content.

12: The brazing sheet according to claim 10 wherein the aluminum alloy comprises magnesium.
